(19) United States
(12) Patent Application Publication
(10) Pub. No.: US 2014/0279194 A1
(43) Pub. Date: Sep. 18, 2014

(54) SKU-DRIVEN APPAREL SIZE DETERMINATION FOR CARDHOLDERS

(71) Applicant: MASTERCARD INTERNATIONAL INCORPORATED, Purchase, NY (US)

(72) Inventor: Justin Xavier Howe, Oakdale, NY (US)

(73) Assignee: MASTERCARD INTERNATIONAL INCORPORATED, Purchase, NY (US)

(21) Appl. No.: 13/841,276

(22) Filed: Mar. 15, 2013

(51) Int. Cl. G06Q 30/06

(52) U.S. Cl. CPC G06Q 30/0631
USPC 705/26.7

(57) ABSTRACT

Repositories of apparel purchase data combined with payment card data can be used to determine accurate cardholder apparel sizes by examining their historical clothing purchases. Using these profiles to identify cardholders with similar figures, and their purchases to extrapolate what sizes to purchase in as yet unpurchased items. The present method can be implemented on an e-commerce platform or in brick & mortar locations, for example as a smartphone app with barcode scanner. Shopping becomes more efficient for cardholders, the retailer sees increased throughput, and returns for size are reduced. No effort by customer is needed.

### BACKGROUND

1. Field of the Disclosure

The present disclosure relates to electronic commerce. More specifically, the present disclosure is directed to method and system for determining a cardholder's clothing size based upon SKU data derived from their purchase history.

2. Brief Discussion of Related Art

Apparel retailers suffer from 50% return rates on eCommerce orders due to incorrect sizes. They have pursued diverse efforts to reduce this return rate problem with a variety of ineffective hardware oriented solutions such as x-ray measurements, robotic torsos conforming to your measurements, and other ideas.

According to a 23 Mar. 2012 report in the Wall Street Journal, in tests with 400,000 users on a website selling denim, a system dubbed TrueFit reduced the return rate for premium denim to 20% from 50%, according to TrueFit's chief executive. The TrueFit solution doesn't work for phone orders, or orders for different sizes placed while in a store. TrueFit further requires the customer be at a computer and near their wardrobe. TrueFit also requires a baseline investment of time by the customer. The system builds a profile of the customer from the purchases visible to it, post-registration. TrueFit claims “access to a large number of fashion labels' garment specifications for both men and women.” TrueFit is engaged with market testing in partnership with Macy's and Nordstrom.

Another operator in this market space is called UPcload. This is the product of a German company that offers size recommendations based on web cam photo uploads by customers to determine their measurements. UPcload is being market tested by North Face and 12 German brands. UPcload users must spend approximately 15 minutes entering their data via a web questionnaire. Users are then photographed, e.g. by webcam or cell/smart phone camera, wearing form fitting clothing while holding a CD or DVD. The algorithm uses the CD/DVD as a point of reference for scale, and thereafter determines accurate measurements of the user's body.

The above-cited Wall Street Journal article states that Macy's is also “looking at futuristic technology that could use cellphone cameras to measure the dimensions of a consumer's body, comparing that to apparel measurements.” This is conceptually related to the UPcload product, though the article does not state if Macy's is partnering with UPcload, or any other source to implement the technology.

Another existing system called Fits.me uses robot mannequins to model different body types. Fits.me claims the ability to model 85% of body types with their FitBots. Fits.me requires that customers enter their height, neck, waist, and wrist measurements, and that the measurements be accurate. The user must then enter those values into the site to use the service. Then they are shown a mannequin wearing the selected garment, having taken on their shape and size via the FitBot proxy. Fits.me requires that retailers and/or manufacturers mail sample garments to Fits.Me for photography on the FitBots. At least one limitation of Fits.me is that the system currently doesn't work for pants. Fits.Me states that industry return rates are 25%, with luxury apparel returns at 40%. They also claim to reduce return rates by 28%, which extrapolates to $31B in US online apparel sales.

A further alternative in the marketplace is called Me-Ality. Me-Ality employs body scanning booths using 3-D body scanning technology to determine customer apparel sizes. This of course requires customers to visit one of approximately 300 booths located in malls throughout the US. Me-Ality can suffer inaccuracies depending on the amount and variety of clothing worn. The process ‘takes less than 10 minutes’ according to its operator. At presently Me-Ality is being targeted exclusively at denim apparel sizing.

A further alternative in the marketplace is called Brayola. Brayola uses crowd-sourced fitting, whereby 10,000 users (in this case, women) have created profiles where they list the bras and sizes in their closet. The site then makes bra recommendations and size recommendations by identifying profiles with similar dimensions, thereby enhancing confidence in the result. Brayola can be understood as an implementation of Instance Based Learning Methods.

All of the foregoing techniques for enhanced sizing of clothing purchasers suffer from drawbacks. All of the methods reviewed above require customer registration in the program, laborious measurements or searching through their closet and manually entering this data in a computer. None of the methods reviewed above offer a solution requiring little or no effort by the customer.

None of the methods reviewed above looks at actual purchase history to estimate size. TrueFit retains a customer profile of purchases after customer registration, if purchases are made at a participating retailer. TrueFit therefore cannot track purchase prior to registration, nor future purchases without retailer participation. None of the methods reviewed above can leverage all historical purchases of the card holder to generate the best possible recommendations. TrueFit can't get every customer to describe their wardrobe, nor can UPcload get every customer to fill out their questionnaire. None of the methods reviewed above can leverage payment card refund data to detect poor fitting merchandise.

The present state of the art is therefore wanting.

### SUMMARY

A far more straight-forward solution to the sizing problem would be to mine the wealth of SKU data from purchase transaction records held in data coops to determine a customer's likely size in one product, based on the sizes they have already purchased in another product, including potentially those products purchased from a different store or manufacturer.

Provided according to the present disclosure is a method of providing a sizing recommendation for a first cardholder with respect to a first garment. The method includes determining, from a transaction record of clothing purchases made using a first transaction card corresponding to the first cardholder, a sizing profile for the first cardholder of the first transaction card. The sizing profile includes a subset of the transaction record that corresponds to a most likely clothing size for the first cardholder. A sizing recommendation related to the first garment is made for the first cardholder by reference to a relationship between the sizing profile of the first cardholder and transaction records within other sizing profiles of other cardholders, which other sizing profiles include items appearing among the transaction records within the sizing profile of the first cardholder. Optionally according to the disclosed method, the subset of the transaction record included in the sizing profile excludes returned items.

A further embodiment of the disclosed method includes determining a sizing profile of the cardholder includes determining a gender of the cardholder. Among the optional techniques to accomplish this are inferring the gender of the cardholder from the transaction record of the cardholder, or obtaining gender information of a cardholder from a third party information source. Inferring the gender of the cardholder from the transaction record of the cardholder comprises one or more techniques including a discriminant analysis, statistical learning based upon sample data, discerning gender-specific merchants from the transaction record, and discerning SKU data in the transaction record.

Making a sizing recommendation may include determining a size of the first garment most common among other cardholder profiles having matching purchases with the transaction record included in the sizing profile of the first cardholder.

A further embodiment of the disclosed method includes compiling a data collection of matched pairs of clothing items that fall within the sizing profiles of a plurality of cardholders, and making a sizing recommendation based upon one or more instances of the first garment among the matched pairs in the data collection.

Further included as part of the present disclosure are a computer-based system for carrying out the foregoing method and any of its optional features. Further disclosed is a non-transitory, machine-readable storage medium, having thereon a program of instruction which, when executed by processor, cause the processor to carrying out the foregoing method and any of its optional features.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

The FIGURE illustrates schematically a computer for implementing the methods according to the present disclosure.

### DETAILED DESCRIPTION

A necessary predicate to practicing the presently disclosed system and methods will be to establish, or have access to an established database (or more colloquially, data warehouse), of transaction data. Such transaction data is most commonly formatted according to ISO 8583, but as used herein may include a subset or some functional equivalent thereof. In particular, transaction data including SKU-level detail of products purchased using the payment device as part of a cashless transaction. One skilled in the art will know how to link credit card purchase data to SKU level data retained post purchase (either done with the card and transaction time, or by store-time-basket price). More preferably, to improve accuracy, all returned items will be removed from the data set. Beginning from a verbose dataset of SKU data such as this taken from hundreds if not thousands of retailers that has already been linked to payment card accounts, requires several additional steps to determine a cardholder's apparel or footwear size.

For simplicity the payment device discussed herein as a payment card, i.e., calling to mind a credit card, debit card, ATM card, etc., which are in ubiquitous present use. However, those skilled in the art will appreciate the present disclosure is equally applicable to any cashless payment device, for example and without limitation PIN-based payment cards, contactless RFID-enabled devices including smart cards, NFC-enabled smartphones, electronic and/or virtual mobile wallets or the like. The “cardholder” herein is therefore emblematic of any user of any such transaction device, real or virtual, by which the device holder as payor, or other party having financial responsibility for the account, and/or said account which source of funds for the payment, may be identified.

Gender Determination

One factor in the sizing process is determining the gender of the cardholder. Knowing the gender of the cardholder will allow filtering of opposite-gender apparel purchased as gifts. The simplest implementation involves the cardholder granting approval for their credit reporting agency to disclose their gender. This could be required as a condition of size recommendations directly to a cardholder. Other implementations that do not require cardholder interaction would require gender inference to be made, for example based upon historical spending patterns.

One such other implementation would be to perform a discriminant analysis to distinguish male and female cardholders. Other implementations rely on statistical learning using training data sets to segregate these groups. The most explicit classifications would rely on Merchant Classification Codes, gender-specific merchants or SKUs for classification. Merchant Classification Codes for manicure shops or salons would be useful predictors, single-gender retailers such as Ann Taylor, Victoria's Secret (although 75% of online purchases are by men), Juicy Couture, Brooks Brothers (85% male), would also be powerful predictors. The most accurate method of gender determination though is compiling SKU statistics from apparel retailers, and determining from the SKU data the predominant gender designation of the set of purchased items for a particular card.

Instance-Based Sizing

After determining the gender of a cardholder, all SKUs purchased with that card can be pooled to create a ‘wardrobe’ table. The table and/or SKU data may be segregated for apparel categories such as male, female, and children. Within each category, a profile of sizes is generated. Outliers may be removed, on the assumption that they represent gifts. All remaining SKUs are assumed to be worn by each ‘profile’. It is possible and within the scope of the present disclosure that multiple profiles are associated per card/cardholder, in consideration for example where an individual buys a regular volume for of clothing for their spouse, a same-gender parent or child (juvenile or grown), or any other individual. However, for the sake of clarity, further explanation will presume and focus upon application to a single ‘profile’ per cardholder.

Every pair of SKUs within each profile is added to a ‘MatchPair’ table. The ‘MatchPair’ table lists each pair of SKUs of the same item type (blouse, skirt, pants, boot, jacket, etc.) in their own ‘MatchPair record’. Every time a ‘MatchPair’ of two SKUs is shared by different cardholders it is incremented. Optionally, the ‘MatchPair’ entries populating this table may be limited in time span between the respective purchases making up each pair. This will allow for the possibility that body type and sizes, even for adults, may change over time.

Therefore, when a particular cardholder is shopping for a given model or style of UGGS boots, a sizing recommendation can be made for them based upon their sizing profile. For example, consider it is desired to make a sizing recommendation for the appropriate size of UGGS boots for Cardholder A, where Cardholder A also bought size 7 ASICS running shoes 3 months ago. Cardholder B had purchased size 8 UGGS boots and the same size 7 ASICS running shoes. That MatchPair reference from Cardholder B (among numerous others), is reflected in the MatchPair table. The recommended side of UGGS for Cardholder A can be estimated by reference to the MatchPair table of other cardholders like B, who also bought the corresponding size 7 ASICS and the same style of UGGS boots. Where multiple sizes of a product are correlated to the same size of a different product, the percentage of total profiles who made that selection can be used to determine the best match. Optionally or additionally, Cardholder A can be apprised of the range of likely sizes where the recommendation cannot be reduced to a single size.

Cross-Retailer Sizing Guide

While the prior instance-based sizing method works well for specific SKU pairs, it is less well suited to correlating purchases in extremely different customer segments. For example, the same cardholder may not often purchase products (meaning specific SKUs) carried by an upmarket retailer, and also those carried by a mass-market retailer. Accordingly, a different means of cross-retailer sizing can provide further utility.

In cases where instance based sizing is not possible, one can return to the standard sizing guides offered by retailers. Such a ‘Cross Retailer Size Guide’ includes one row for every size offered by a retailer, whether it is Pant XS, Pant XS-Petite, or Pant 28W-28H, etc. Each column in a given row indicates the most common size worn in that store by cardholders/profiles, who wear the size shown in the farthest left column. Entries can be populated initially from information provided with a retailer's or clothing manufacturer's size guides. The table can be subsequently revised with data from the instance-based profiles.

It will be appreciated by those skilled in the art that the methods as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

Turning then to the FIGURE, illustrated schematically is a representative computer 616 of the system 600. The computer 616 includes at least a processor or CPU 622 which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a GUI.

More particularly, the sizing recommendation can be made as part of an e-commerce payment platform, and offered as a service enhancement for customers making e-commerce clothing purchases online, for example as an enticement to use a transaction card offering the sizing recommendations in order to complete payment on the transaction, or optionally as a stand-alone service. The service may be invoked by the retailer, either in-store or in an e-commerce transaction, with the customer providing their card details to the payment network operator, who makes the size recommendation accordingly.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of providing a sizing recommendation for a first cardholder seeing to purchase a first garment, the method comprising:
determining, from a transaction record of clothing purchases made using a first transaction card corresponding to the first cardholder, a sizing profile for the first cardholder of the first transaction card, wherein the sizing profile includes a subset of the transaction record that corresponds to a most likely clothing size for the first cardholder; and
making a sizing recommendation related to the first garment for the first cardholder by reference to a relationship between the sizing profile of the first cardholder and transaction records within other sizing profiles of other cardholders, which other sizing profiles include items appearing among the transaction records within the sizing profile of the first cardholder.

2. The method according to claim 1, determining a sizing profile of the cardholder includes determining a gender of the cardholder.

3. The method according to claim 2, wherein determining the gender of a cardholder comprises inferring the gender of the cardholder from the transaction record of the cardholder, or obtaining gender information of a cardholder from a third party information source.

4. The method according to claim 3, wherein inferring the gender of the cardholder from the transaction record of the cardholder comprises one or more techniques including a discriminant analysis, statistical learning based upon sample data, discerning gender-specific merchants from the transaction record, and discerning SKU data in the transaction record.

5. The method according to claim 1, wherein the subset of the transaction record included in the sizing profile excludes returned items.

6. The method according to claim 1, wherein making a sizing recommendation comprises determining a size of the first garment most common among other cardholder profiles having matching purchases with the transaction record included in the sizing profile of the first cardholder.

7. The method according to claim 1, further comprising compiling a data collection of matched pairs of clothing items that fall within the sizing profiles of a plurality of cardholders, and making a sizing recommendation based upon one or more instances of the first garment among the matched pairs in the data collection.

8. A non-transitory machine-readable storage medium, having thereon a program of instruction which, when executed by processor, cause the processor to:
determine, from a transaction record of clothing purchases made using a first transaction card corresponding to the first cardholder, a sizing profile for the first cardholder of the first transaction card, wherein the sizing profile includes a subset of the transaction record that corresponds to a most likely clothing size for the first cardholder; and
make a sizing recommendation related to the first garment for the first cardholder by reference to a relationship between the sizing profile of the first cardholder and transaction records within other sizing profiles of other cardholders, which other sizing profiles include items appearing among the transaction records within the sizing profile of the first cardholder.

9. The medium according to claim 8, determining a sizing profile of the cardholder includes determining a gender of the cardholder.

10. The medium according to claim 9, wherein determining the gender of a cardholder comprises inferring the gender of the cardholder from the transaction record of the cardholder, or obtaining gender information of a cardholder from a third party information source.

11. The medium according to claim 10, wherein inferring the gender of the cardholder from the transaction record of the cardholder comprises one or more techniques including a discriminant analysis, statistical learning based upon sample data, discerning gender-specific merchants from the transaction record, and discerning SKU data in the transaction record.

12. The medium according to claim 8, wherein the subset of the transaction record included in the sizing profile excludes returned items.

13. The medium according to claim 8, wherein making a sizing recommendation comprises determining a size of the first garment most common among other cardholder profiles having matching purchases with the transaction record included in the sizing profile of the first cardholder.

14. The medium according to claim 8, further comprising compiling a data collection of matched pairs of clothing items that fall within the sizing profiles of a plurality of cardholders, and making a sizing recommendation based upon one or more instances of the first garment among the matched pairs in the data collection.

15. A system for monitoring cashless transaction data, the system comprising:
a computer including a processing device and a non-transitory, machine-readable storage medium, having thereon a program of instruction which, when executed by processor, cause the processor to:
determine, from a transaction record of clothing purchases made using a first transaction card corresponding to the first cardholder, a sizing profile for the first cardholder of the first transaction card, wherein the sizing profile includes a subset of the transaction record that corresponds to a most likely clothing size for the first cardholder; and
make a sizing recommendation related to the first garment for the first cardholder by reference to a relationship between the sizing profile of the first cardholder and transaction records within other sizing profiles of other cardholders, which other sizing profiles include items appearing among the transaction records within the sizing profile of the first cardholder.

16. The system according to claim 15, determining a sizing profile of the cardholder includes determining a gender of the cardholder.

17. The system according to claim 16, wherein determining the gender of a cardholder comprises inferring the gender of the cardholder from the transaction record of the cardholder, or obtaining gender information of a cardholder from a third party information source.

18. The system according to claim 17, wherein inferring the gender of the cardholder from the transaction record of the cardholder comprises one or more techniques including a discriminant analysis, statistical learning based upon sample data, discerning gender-specific merchants from the transaction record, and discerning SKU data in the transaction record.

19. The system according to claim 15, wherein the subset of the transaction record included in the sizing profile excludes returned items.

20. The system according to claim 15, wherein making a sizing recommendation comprises determining a size of the first garment most common among other cardholder profiles having matching purchases with the transaction record included in the sizing profile of the first cardholder.

21. The system according to claim 15, further comprising compiling a data collection of matched pairs of clothing items that fall within the sizing profiles of a plurality of cardholders, and making a sizing recommendation based upon one or more instances of the first garment among the matched pairs in the data collection.
